(19) United States
(12) Patent Application Publication
(10) Pub. No.: US 2024/0036152 A1
(43) Pub. Date: Feb. 1, 2024

(54) COMMUNICATION DEVICE, INFERENCE DEVICE, AND INFORMATION PROCESSING METHOD

(71) Applicant: Toshiba Tec Kabushiki Kaisha, Tokyo (JP)

(72) Inventors: Takashi TOMIYAMA, Sunto Shizuoka (JP); Hiroyuki ISHIKAWA, Sunto Shizuoka (JP)

(21) Appl. No.: 18/334,174

(22) Filed: Jun. 13, 2023

(30) Foreign Application Priority Data
Jul. 27, 2022 (JP) 2022-119996

(51) Int. Cl. G01S 5/02; G01S 5/06

(52) U.S. Cl. CPC G01S 5/0269; G01S 5/06; G01S 5/0249

(57) ABSTRACT

According to one embodiment, a wireless tag reading device has an antenna to receive a radio wave transmitted from a wireless tag, a drive unit to move the antenna through different positions along a fixed path, a detection unit configured to determine a received signal strength and a phase of the radio wave received by the antenna, and a processor. The processor receives position data indicating a position of the antenna in conjunction with the received signal strength and the phase of the radio signal at the position, calculates in-phase and quadrature data for the wireless tag at a plurality of positions of the antenna, then inputs the in-phase and the quadrature data to a learned model correlating in-phase data and quadrature data to positions of wireless tags to estimate a position of the wireless tag.

### CROSS-REFERENCE TO RELATED APPLICATION

This application is based upon and claims the benefit of priority from Japanese Patent Application No. 2022-119996, filed Jul. 27, 2022, the entire contents of which are incorporated herein by reference.

### FIELD

Embodiments described herein relate generally to a communication device, an inference device, and an information processing method.

### BACKGROUND

There is a device that receives, via an antenna, a radio wave transmitted from a wireless tag attached to an article and determines the position of the wireless tag. In this context, a position determination may be an indication such as whether the wireless tag is within a predetermined range or out of the predetermined range. Such a device may move the antenna and detect a phase of the radio wave from the wireless tag.

To determine the position of the wireless tag, identifying a relationship between the position of the antenna and the detected phase by machine learning has been considered. While the position of the antenna changes continuously, the phase changes from 360° to 0° or from 0° to 360° at a certain point. At such a point, the change in the phase is discontinuous while the position of the antenna changes continuously. Machine learning tends to identify a point where the phase changes discontinuously as a relevant feature.

However, since the position of the antenna changes continuously, the point where the phase changes discontinuously from 360° to 0° or from 0° to 360° is generally not suitable for use a relevant feature. Therefore, if the phase expressed by the values from 0° to 360° is directly used for machine learning, the accuracy of position determination for the wireless tag may be reduced.

### BRIEF DESCRIPTION OF THE DRAWINGS

FIG. 1 is a block diagram of a communication system according to a first embodiment.

FIG. 2 is a block diagram of a reading device.

FIG. 3 shows an example of a data structure for measurement data.

FIG. 4 is a graph showing an example of RSSI data.

FIG. 5 is a graph showing an example of phase data.

FIG. 6 is a graph showing an example of in-phase data and quadrature-phase data.

FIG. 7 shows an example of a data structure for converted data.

FIG. 8 is a block diagram of a drive device.

FIG. 9 is a schematic view for explaining aspects of a drive device.

FIG. 10 is a schematic view for explaining aspects of a first range and a second range.

FIG. 11 is a flowchart of determination processing by a processor of a reading device.

FIG. 12 is a flowchart of learned model generation processing by a processor.

FIG. 13 is a block diagram of a communication system according to a second embodiment.

FIG. 14 is a block diagram of an inference device.

FIG. 15 is a flowchart of determination processing by a processor of an inference device.

### DETAILED DESCRIPTION

An embodiment described herein provides a technique that improves the accuracy in the determining of the position of a wireless tag.

In general, according to one embodiment, a wireless tag reading device includes an antenna configured to receive a radio wave transmitted from a wireless tag, a drive unit configured to move the antenna through different positions along a fixed path, a detection unit configured to determine a received signal strength and a phase of the radio wave received by the antenna, and a processor. The processor is configured to: receive position data indicating a position of the antenna in conjunction with the received signal strength and the phase of the radio signal received by the antenna at the position, calculate in-phase data and quadrature data for the wireless tag based on the received signal strength and the phase of the radio signal at a plurality of positions of the antenna, input the in-phase data and the quadrature data for the wireless tag to a learned model correlating in-phase data and quadrature data to positions of wireless tags, and estimate a position of the wireless tag using output of the learned model.

### First Embodiment

A communication system according to a first embodiment will now be described, using the drawings. In each drawing used for the description of the first embodiment given below, the scale of each part may be changed where appropriate. In each drawing used for the description of the first embodiment given below, some components may be omitted for the sake of convenience of description.

### Example of Configuration

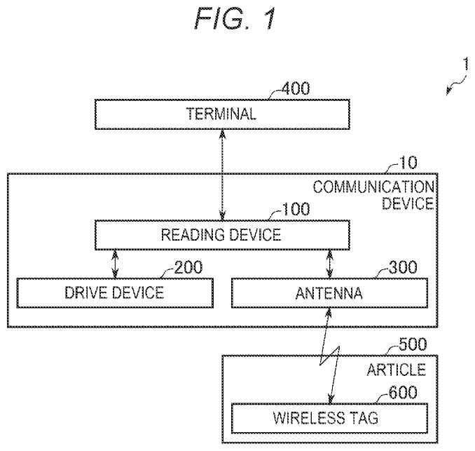

FIG. 1 is a block diagram showing an example of the configuration of a communication system 1.

The communication system 1 includes a communication device 10, a terminal 400, and one or more wireless tags 600 attached to one or more articles 500. While FIG. 1 shows one wireless tag 600 attached to one article 500, the communication system 1 may include a plurality of wireless tags 600 attached to a plurality of articles 500. The communication system 1 includes the communication device 10 and the terminal 400 but may not include the one or more articles 500. The communication system 1 is an example of an information processing system.

The communication device 10 is an electronic device wirelessly communicating with the wireless tag 600. The communication device 10 can be used for product inspection, tracking, or the like in a warehouse but may also be used in a retail store or the like. The possible applications of the communication device 10 are not particularly limited to these examples. The communication device 10 includes a reading device 100, a drive device 200, and an antenna 300.

The reading device 100 is an electronic device that controls the drive device 200 and the antenna 300 to read information from a wireless tag 600. The reading device 100 is also a device that controls the drive device 200 and the antenna 300 to detect tag data related to the wireless tag 600. The meaning of “detect” in this context includes “measure” such as with respect to detecting or measuring a response signal strength or other signal parameters of a signal received from a wireless tag 600. In this context, “tag data” can be time-series data based on the radio wave(s) transmitted from the wireless tag 600. The tag data may include RSSI (received signal strength indicator) data and phase data. The RSSI indicates the received strength of a response signal. The received strength is also referred to as received radio wave strength or received signal strength. The RSSI data is data representing the RSSI of the radio wave transmitted from the wireless tag 600. The phase data is data representing the phase of the radio wave transmitted from the wireless tag 600. The radio wave transmitted from the wireless tag 600 is also referred to as radio wave or response signal from the wireless tag 600. The tag data of the radio wave transmitted from the wireless tag 600 is also referred to as tag data for the wireless tag 600. The RSSI data of the radio wave transmitted from the wireless tag 600 is also referred to as RSSI data for the wireless tag 600. The phase data of the radio wave transmitted from the wireless tag 600 is also referred to as phase data for the wireless tag 600.

The drive device 200 is an electronic device that moves the antenna 300. Moving the antenna 300 includes moving the position of the antenna 300.

The antenna 300 communicates with the wireless tag 600. The antenna 300 transmits a radio wave. The antenna 300 receives a radio wave transmitted from the wireless tag 600. The radio wave transmitted from the wireless tag 600 is an example of a response wave from the wireless tag 600 to the radio wave transmitted from the antenna 300. The antenna 300 converts the received radio wave into a high-frequency signal and outputs the high-frequency signal to the reading device 100.

The terminal 400 is an electronic device that processes information read by the reading device 100 from the wireless tag 600. The terminal 400 is a PC (personal computer) or the like. However, in general, the terminal 400 may be any device that processes information, and is not limited to this example. The terminal 400 is an example of an information processing terminal.

The article 500 is, for example, an item of merchandise or the like.

Determining the position of the wireless tag 600 may include determining a range in which the position of the wireless tag 600 exists. Determining the range in which the position of the wireless tag 600 exists may include determining whether the position of the wireless tag 600 is within a first range or not. Determining whether the position of the wireless tag 600 is included in the first range or not may include specifically determining in which of the first range or a second range the wireless tag 600 is located. In this context, the first range and the second range are different ranges that do not overlap each other. For example, the first range and the second range are three-dimensional ranges. The first range and the second range may be directly adjacent to each other or may be spaced from each other. The meaning of “range” in this context includes the meaning of “area” and/or “volume”. The first range is an example of a predetermined range.

The wireless tag 600 is an IC tag including an IC chip and an antenna. The wireless tag 600 is typically an RFID (radio frequency identification) tag. The wireless tag 600 may be another type of IC tag other than an RFID tag. The wireless tag 600 is a passive wireless tag that operates, using the radio wave transmitted from the antenna 300 as the source of energy for generating a response wave. The wireless tag 600 performs backscatter modulation of an unmodulated signal and thus transmits, via its own antenna, a signal including the information stored in the IC chip of the wireless tag 600. The information stored in the wireless tag 600 may include univocally (uniquely) identifiable information. The information stored in the wireless tag 600 may include information about the article 500 to which the wireless tag 600 is attached. The information about the article 500 may be a unique identification code.

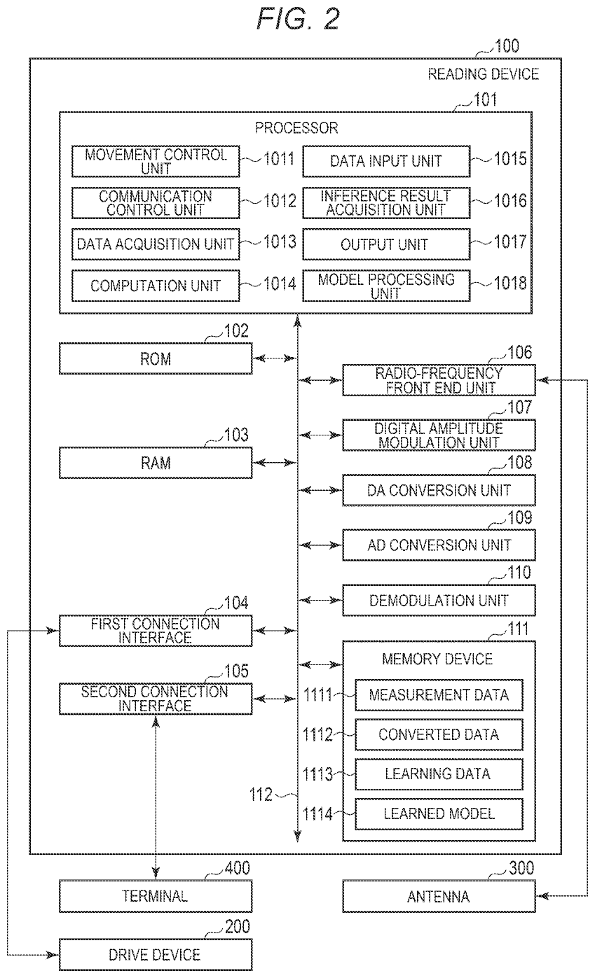

The reading device 100 will now be described using FIG. 2.

FIG. 2 is a block diagram showing an example of the configuration of the reading device 100.

The reading device 100 includes a processor 101, a ROM (read-only memory) 102, a RAM (random-access memory) 103, a first connection interface 104, a second connection interface 105, a radio-frequency front end unit 106, a digital amplitude modulation unit 107, a DA (digital-to-analog) conversion unit 108, an AD (analog-to-digital) conversion unit 109, a demodulation unit 110, and a memory device 111. These components included in the reading device 100 are connected to each other via a bus 112 or the like.

The processor 101 is equivalent to a central part of a computer that performs necessary processing such as computation and control for the operation of the reading device 100. The processor 101 loads various programs stored in the ROM 102 or the memory device 111 or the like into the RAM 103. The program is a program for causing the processor 101 to execute various kinds of processing. The processor 101 executes the program loaded in the RAM 103, thus implements units, described below, and executes various kinds of processing.

The processor 101 can be a CPU (central processing unit), an MPU (micro-processing unit), a SoC (system on a chip), a DSP (digital signal processor), a GPU (graphics processing unit), an ASIC (application-specific integrated circuit), a PLD (programmable logic device), or an FPGA (field-programmable gate array) or the like. The processor 101 may be a combination of a plurality of devices such as described. The processor 101 is an example of a processing circuit.

The ROM 102 is a non-volatile memory used exclusively to read data. The ROM 102 stores the foregoing program. The ROM 102 stores data or various set values or the like used by the processor 101 to perform various kinds of processing.

The RAM 103 is a memory used to read and write data. The RAM 103 is a work area for storing data temporarily used by the processor 101 to perform various kinds of processing. The RAM 103 is an example of a memory unit.

The first connection interface 104 is an interface for the reading device 100 to communicate with the drive device 200.

The second connection interface 105 is an interface for the reading device 100 to communicate with the terminal 400.

The radio-frequency front end unit 106 outputs a high-frequency signal to the antenna 300. The radio-frequency front end unit 106 takes in a high-frequency signal inputted from the antenna 300.

The digital amplitude modulation unit 107 is a circuit that adds data to be transmitted to the wireless tag 600, to a carrier wave to be transmitted to the wireless tag 600.

The DA conversion unit 108 is a circuit that converts a digital signal into an analog signal. The DA conversion unit 108 converts a digital signal modulated by the digital amplitude modulation unit 107 into an analog signal. The DA conversion unit 108 outputs a high-frequency signal to the antenna 300 via the radio-frequency front end unit 106.

The AD conversion unit 109 is a circuit that converts an analog signal into a digital signal. The AD conversion unit 109 converts a high-frequency signal inputted from the antenna 300 via the radio-frequency front end unit 106 into a digital signal.

The demodulation unit 110 is a circuit that acquires information based on the radio wave received by the antenna 300 from the wireless tag 600. For example, the demodulation unit 110 acquires the information stored in the wireless tag 600 from the digital signal converted by the AD conversion unit 109, by a known technique. The demodulation unit 110 is an example of an information acquisition unit configured to acquire the information stored in the wireless tag 600 based on the radio wave from the wireless tag 600.

The demodulation unit 110 is also a circuit that detects tag data based on the radio wave from the wireless tag 600 received by the antenna 300. The demodulation unit 110 can detect the RSSI data of the radio wave in time series from the digital signal converted by the AD conversion unit 109, by a known technique. The demodulation unit 110 can detect the phase data of the radio wave in time series from the digital signal converted by the AD conversion unit 109, by a known technique. The demodulation unit 110 is an example of a detection unit configured to detect the RSSI data and the phase data of the radio wave from the wireless tag 600 received by the antenna 300.

The memory device 111 includes a non-volatile memory storing data and a program or the like. The memory device 111 can be or include an HDD (hard disk drive) or an SSD (solid-state drive) or the like but is not limited to these examples. The memory device 111 is an example of a memory unit.

The memory device 111 stores measurement data 1111.

The measurement data 1111 includes the tag data detected by the demodulation unit 110 during a movement of the antenna 300 along one direction. For example, the one direction is a horizontal direction. The measurement data 1111 includes a tag data set for each wireless tag 600. The tag data set of a wireless tag 600 is an aggregate of multiple instances of tag data for the wireless tag 600 that have been detected by the demodulation unit 110. The tag data set of a wireless tag 600 includes position data of the antenna 300 and tag data for the wireless tag 600 for a plurality of positions of the antenna 300. Each item of tag data is correlated with position data of the antenna 300. The plurality of positions of the antenna 300 may include positions at a predetermined interval within a range from a position 0 (corresponding to a home position) to a position L. The range from the position 0 to the position L is assumed to be the scanning area of the antenna 300. The position 0 is an example of a first position. The position L is an example of a second position. The value of the predetermined interval can be suitably set or adjusted. The position L can be suitably set or adjusted. Depending on the wireless tag 600, the demodulation unit 110 may detect the tag data for all of the positions at the predetermined intervals within the range from the position 0 to the position L. Depending on the wireless tag 600, the demodulation unit 110 may detect the tag data for only some of the positions at the predetermined intervals within the range from the position 0 to the position L. The measurement data 1111 can be updated.

While an example where the memory device 111 stores the measurement data 1111 is described, this example is not limiting. The RAM 103 may store the measurement data 1111.

The memory device 111 stores converted data 1112.

The converted data 1112 includes data converted based on the tag data included in the measurement data 1111. The converted data 1112 includes a converted tag data set of each wireless tag 600. The converted tag data set of a wireless tag 600 is an aggregate of in-phase data and quadrature data for the wireless tag 600 converted based on the RSSI data and the phase data for the wireless tag 600. The converted tag data set of the wireless tag 600 includes the position data of the antenna 300 and a plurality of in-phase data and a plurality of quadrature data for the wireless tag 600 in relation to a plurality of positions of the antenna 300. The in-phase data and the quadrature data for the wireless tag 600 are correlated with the position data of the antenna 300. The converted data 1112 can be updated.

An example of the conversion from the RSSI data and the phase data for the wireless tag 600 to the in-phase data and the quadrature data for the wireless tag 600 will now be described. The in-phase data and the quadrature data for the wireless tag 600 are data converted based on normalized RSSI data and the phase data for the wireless tag 600. The normalized RSSI data for the wireless tag 600 is data formed by normalizing the RSSI data for the wireless tag 600, based on a predetermined signal strength. In this example, the predetermined signal strength is −80 dBm, which is assumed to be the minimum signal strength of a response from the wireless tag 600 that can be received by the antenna 300. However, the predetermined signal strength is not limited to this example.

The normalized RSSI data can be found by the equation given below, based on the RSSI data.

Normalized RSSI=(RSSI+80)/80

The in-phase data can be found by the equation given below, based on the normalized RSSI data and the phase data. Data_I represents the in-phase data.

Data_I=(normalized RSSI)×cos(phase×π/180)

The quadrature data can be found by the equation given below, based on the normalized RSSI data and the phase data. Data_Q represents the quadrature data.

Data_Q=(normalized RSSI)×sin(phase×π/180)

While an example where the memory device 111 stores the converted data 1112 is described, this example is not limiting. The RAM 103 may store the converted data 1112.

The memory device 111 stores learning data 1113.

The learning data 1113 includes a converted tag data set for each of a plurality of learning target wireless tags. A learning target wireless tag is an example of a wireless tag configured similarly to a wireless tag 600. The converted tag data set of the learning target wireless tag is an aggregate of in-phase data and quadrature data for the learning target wireless tag. The in-phase data and the quadrature data for the learning target wireless tag are data converted based on RSSI data and phase data of a radio wave transmitted from the learning target wireless tag detected by a reading device in advance. The reading device may be the same reading device as the reading device 100 or may be a different reading device from the reading device 100. The RSSI data of the radio wave transmitted from the learning target wireless tag is also referred to as RSSI data for the learning target wireless tag. The phase data of the radio wave transmitted from the learning target wireless tag is also referred to as phase data for the learning target wireless tag. The converted tag data set of the learning target wireless tag includes a plurality of in-phase data and a plurality of quadrature data for the learning target wireless tag in relation to a plurality of positions of an antenna. The antenna may be the same antenna as the antenna 300 or may be a different antenna from the antenna 300. The in-phase data and the quadrature data for the learning target wireless tag are correlated with the position data of the antenna. The learning data 1113 includes a plurality of converted tag data sets and thus includes the in-phase data and the quadrature data for a plurality of learning target wireless tags in relation to a plurality of positions of the antenna.

An example of the conversion from the RSSI data and the phase data for the learning target wireless tag to the in-phase data and the quadrature data for the learning target wireless tag will now be described. The in-phase data and the quadrature data for the learning target wireless tag are data converted based on normalized RSSI data and the phase data for the learning target wireless tag. The normalized RSSI data for the learning target wireless tag is data generated by normalizing the RSSI data for the learning target wireless tag based on a predetermined signal strength. The normalized RSSI data for the learning target wireless tag can be found by the same equation as for finding the normalized RSSI data for the wireless tag 600. The in-phase data for the learning target wireless tag can be generated based on the normalized RSSI data and the phase data for the learning target wireless tag. The in-phase data for the learning target wireless tag can be found by the same equation as the equation for finding the in-phase data for the wireless tag 600. The quadrature data for the learning target wireless tag can be found by the equation given below based on the normalized RSSI data and the phase data for the learning target wireless tag. The quadrature data for the learning target wireless tag can be found by the same equation as for the quadrature data for the wireless tag 600.

The learning data 1113 includes ground truth data indicating the position of each of the learning target wireless tags. The data indicating the position of a learning target wireless tag may include data representing a range in which the position of the learning target wireless tag exists. The data representing the range in which the position of the learning target wireless tag exists may include data indicating whether the position of the learning target wireless tag is in the first range or not. The data indicating whether the position of the learning target wireless tag is in the first range or not may include data indicating in which of the first range or the second range the learning target wireless tag is located. The ground truth data can be data input by the user for training purposes or the like. The learning data 1113 can be updated.

The memory device 111 stores a learned model 1114.

The learned model 1114 is a model generated by machine learning using the learning data 1113. The meaning of the term “generate” in this context includes not only newly creating something but also updating something already existing. The learned model 1114 is used to identify (determine) the position of the wireless tag 600. The learned model 1114 outputs output data (location data) for each wireless tag 600 based on the input of input data for each wireless tag 600. The input data includes the position data of the antenna 300 and the in-phase data and the quadrature data for the wireless tag 600 for each of multiple positions of the antenna 300. The in-phase data and the quadrature data for the wireless tag 600 are correlated with the position of the antenna 300. The output data (location data) includes data indicating the position of the wireless tag 600. The data indicating the position of the wireless tag 600 may include data representing the range in which the position of the wireless tag 600 exists. The data representing the range where the position of the wireless tag 600 exists may include data indicating whether the position of the wireless tag 600 is included in the first range or not. The data indicating whether the position of the wireless tag 600 is included in the first range or not may include data indicating which of the first range or the second range the wireless tag 600 is located.

The bus 112 includes a control bus, an address bus, and a data bus or the like. The bus 112 transmits a signal communicated between the components of the reading device 100.

The hardware configuration of the reading device 100 is not limited to the foregoing configuration. In the reading device 100, one or more of the described components may be omitted or modified and/or a new component may be added where appropriate.

Each unit implemented by the processor 101 will now be described.

The processor 101 implements a movement control unit 1011, a communication control unit 1012, a data acquisition unit 1013, a computation unit 1014, a data input unit 1015, an inference result acquisition unit 1016, an output unit 1017, and a model processing unit 1018. Each unit implemented by the processor 101 can also be referred to as a function or operation of the processor 101. It can also be said that each unit implemented by the processor 101 is implemented by a control unit incorporating the processor 101, the ROM 102, and the RAM 103.

The movement control unit 1011 controls the drive device 200 and thus controls the movement of the antenna 300 along one direction.

The communication control unit 1012 controls the start and end of transmission of a radio wave from the antenna 300.

The data acquisition unit 1013 acquires the tag data about each wireless tag 600 detected by the demodulation unit 110 in relation to a plurality of positions of the antenna 300.

The computation unit 1014 executes conversion processing of finding the converted data 1112, based on the measurement data 1111. For example, the computation unit 1014 converts the RSSI data and the phase data for the wireless tag 600 into the in-phase data and the quadrature data for the wireless tag 600, based on the measurement data 1111. Converting the RSSI data and the phase data for the wireless tag 600 into the in-phase data and the quadrature data for the wireless tag 600 includes finding the in-phase data and the quadrature data for the wireless tag 600, based on the RSSI data and the phase data for the wireless tag 600.

The data input unit 1015 receives the input data for each wireless tag 600 and provides the data to the learned model 1114.

The inference result acquisition unit 1016 acquires the output data for each wireless tag 600 from the learned model 1114 based on input data for the wireless tag 600.

The output unit 1017 outputs a result of inference to the terminal 400. The result of inference includes the data indicating the position of each wireless tag 600 in the output data as determined (inferred) by the inference result acquisition unit 1016.

The model processing unit 1018 generates the learned model 1114.

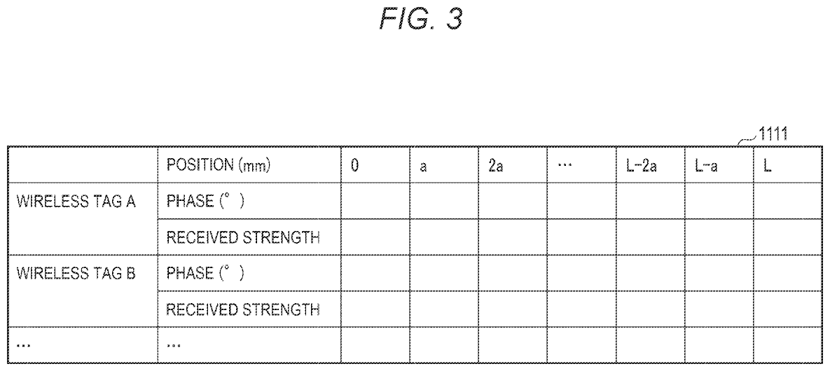

FIG. 3 shows an example of the data structure of the measurement data 1111.

The measurement data 1111 includes the tag data set of each wireless tag 600. The tag data set of the wireless tag 600 includes a plurality of tag data for the wireless tag 600 in relation to a plurality of positions of the antenna 300. For example, the tag data set of the wireless tag 600 includes a plurality of RSSI data for the wireless tag 600 in relation to a plurality of positions of the antenna 300. The tag data set of the wireless tag 600 includes RSSI data correlated with at least some of the positions at a predetermined interval a within the range from the position 0 to the position L. The tag data set of the wireless tag 600 may include RSSI data correlated with each position that is different from the positions at the predetermined interval a within the range from the position 0 to the position L. For example, the tag data set of the wireless tag 600 includes a plurality of phase data for the wireless tag 600 in relation to a plurality of positions of the antenna 300. The tag data set of the wireless tag 600 includes phase data correlated with at least some of the positions at the predetermined interval a within the range from the position 0 to the position L. The tag data set of the wireless tag 600 may include phase data correlated with each position that is different from the positions at the predetermined interval a within the range from the position 0 to the position L.

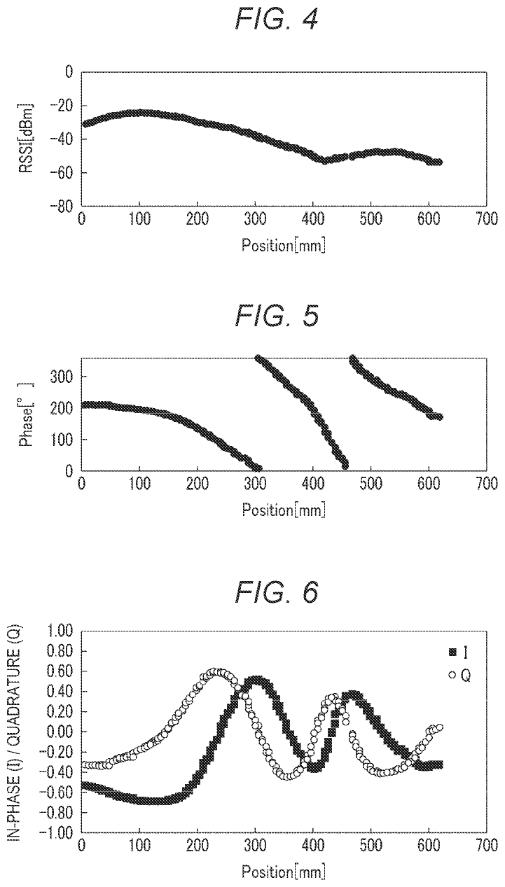

FIG. 4 is a graph showing an example of the RSSI data.

The horizontal axis represents the position of the antenna 300 along one horizontal direction. The vertical axis represents the RSSI value. The graph shows the RSSI value in relation to each of a plurality of positions within the range from the position 0 to the position L, with respect to any one wireless tag 600.

The RSSI value for the wireless tag 600 changes as the position of the antenna 300 changes. This is because the distance between the antenna 300 and the wireless tag 600 changes as the antenna 300 moves. The RSSI value for the wireless tag 600 depends on the distance between the antenna 300 and the wireless tag 600. Therefore, the pattern of the graph of the RSSI data for the wireless tag 600 varies depending on the position of the wireless tag 600.

FIG. 5 is a graph showing an example of the phase data.

The horizontal axis represents the position of the antenna 300 along one horizontal direction. The vertical axis represents the value of the phase. The graph shows the value of the phase in relation to each of the plurality of positions within the range from the position 0 to the position L with respect to any one wireless tag 600 for which the RSSI data illustrated in FIG. 4 is acquired.

The value of the phase for the wireless tag 600 changes as the position of the antenna 300 changes. This is because the distance between the antenna 300 and the wireless tag 600 changes as the antenna 300 moves. The value of the phase for the wireless tag 600 depends on the distance between the antenna 300 and the wireless tag 600. Therefore, the pattern of the graph of the phase data for the wireless tag 600 varies depending on the position of the wireless tag 600.

As can be understood from the graph illustrated in FIG. 5, there are two points where the phase discontinuously changes from 0° to 360° while the position of the antenna 300 continuously changes.

FIG. 6 is a graph showing an example of the in-phase data and the quadrature data.

The horizontal axis represents the position of the antenna 300 along one horizontal direction. The vertical axis represents the in-phase value or the quadrature value. The in-phase data and the quadrature data are data converted based on the RSSI data illustrated in FIG. 4 and the phase data illustrated in FIG. 5.

The in-phase value and the quadrature value for the wireless tag 600 are values converted based on the RSSI value and the value of the phase. Therefore, the in-phase value and the quadrature value change as the position of the antenna 300 changes. The in-phase value and the quadrature value for the wireless tag 600 depend on the distance between the antenna 300 and the wireless tag 600, similarly to the RSSI value and the value of the phase for the wireless tag 600. Therefore, the pattern of the graph of the in-phase data for the wireless tag 600 varies depending on the position of the wireless tag 600. The pattern of the graph of the quadrature data for the wireless tag 600 varies depending on the position of the wireless tag 600.

As can be understood from the graph illustrated in FIG. 6, unlike the phase, the in-phase value continuously changes while the position of the antenna 300 continuously changes. Therefore, there is no point where the in-phase value changes discontinuously. Similarly, the quadrature value continuously changes while the position of the antenna 300 continuously changes. Therefore, there is no point where the quadrature value changes discontinuously.

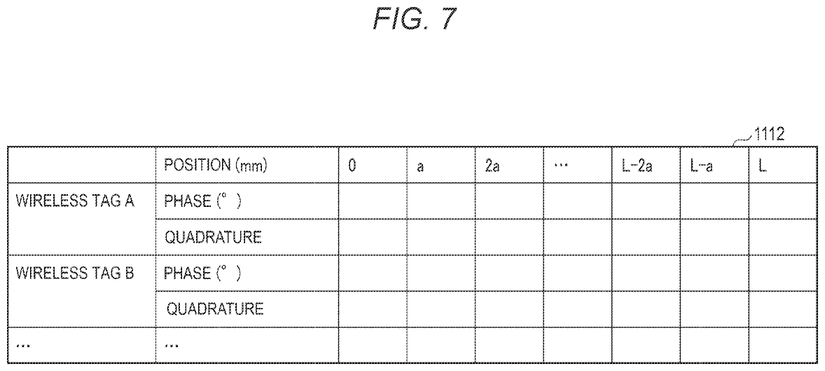

FIG. 7 shows an example of the data structure of the converted data 1112.

The converted data 1112 includes the converted tag data set of each wireless tag 600. For example, the converted tag data set of the wireless tag 600 includes a plurality of in-phase data for the wireless tag 600 in relation to a plurality of positions of the antenna 300. The converted tag data set of the wireless tag 600 includes in-phase data correlated with at least some of the positions at the predetermined interval a within the range from the position 0 to the position L. The converted tag data set of the wireless tag 600 may include in-phase data correlated with each position that is different from the positions at the predetermined interval a within the range from the position to the position L. For example, the converted tag data set of the wireless tag 600 includes a plurality of quadrature data for the wireless tag 600 in relation to a plurality of positions of the antenna 300. The converted tag data set of the wireless tag 600 includes quadrature data correlated with at least some of the positions at the predetermined interval a within the range from the position 0 to the position L. The converted tag data set of the wireless tag 600 may also or instead include quadrature data correlated with positions other than the positions at the predetermined interval a within the range from the position 0 to the position L.

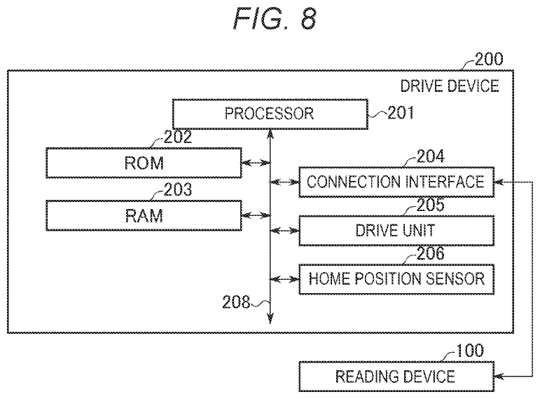

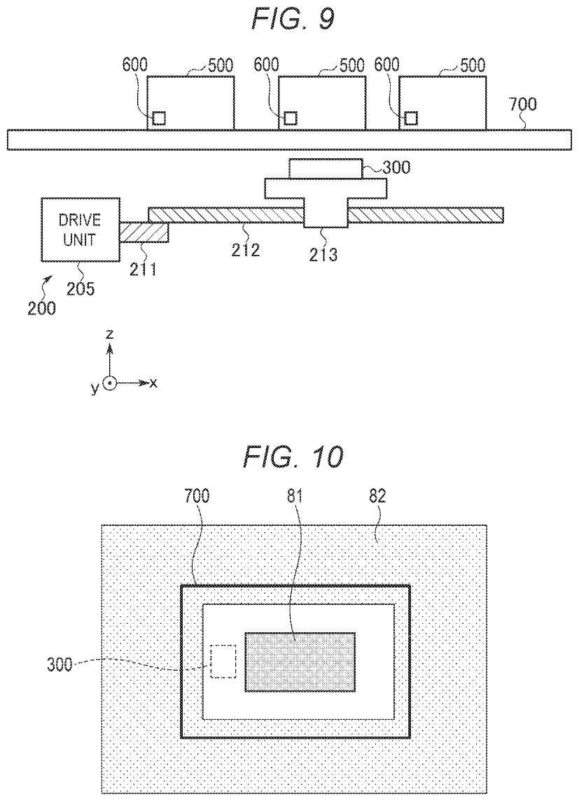

The drive device 200 will now be described, using FIGS. 8 and 9.

FIG. 8 is a block diagram showing an example of the configuration of the drive device 200.

The drive device 200 includes a processor 201, a ROM 202, a RAM 203, a connection interface 204, a drive unit 205, and a home position sensor 206. These components included in the drive device 200 are connected to each other via a bus 208 or the like.

The processor 201 is equivalent to a central part of a computer that performs necessary processing such as computation and control for the operation of the drive device 200. The processor 201 loads various programs stored in the ROM 202 or the like into the RAM 203. The program is a program for causing the processor 201 to execute various kinds of processing. The processor 201 executes the program loaded in the RAM 203 and thus executes various kinds of processing. The processor 201 is a CPU, an MPU, a SoC, a DSP, a GPU, an ASIC, a PLD, or an FPGA or the like. The processor 201 may be a combination of a plurality of devices, of these devices. The processor 201 is an example of a processing circuit.

The ROM 202 is a non-volatile memory used exclusively to read data. The ROM 202 stores the foregoing program. The ROM 202 stores data or various set values or the like used by the processor 201 to perform various kinds of processing.

The RAM 203 is a memory used to read and write data. The RAM 203 is a work area for storing data temporarily used by the processor 201 to perform various kinds of processing.

The connection interface 204 is an interface for the drive device 200 to communicate with the reading device 100.

The drive unit 205 moves the antenna 300. For example, the drive unit 205 is a stepper motor.

The home position sensor 206 is a sensor that detects whether a moving stage 213 is at a home position or not.

The bus 208 includes a control bus, an address bus, and a data bus or the like. The bus 208 transmits a signal communicated between the components of the drive device 200.

FIG. 9 is a schematic view for explaining the drive device 200.

The drive device 200 includes, for example, a rotary shaft 211, a rail 212, and the moving stage 213.

As illustrated in FIG. 9, the drive device 200 and the antenna 300 are arranged below a counter table 700. The counter table 700 provides a horizontal surface where the article 500 (with the wireless tag 600 attached thereto) can be placed. The counter table 700 is an example of a placement unit. The counter table 700 may be included in the communication system 1 or the communication device 10.

The rotary shaft 211 transmits the drive force of the drive unit 205. A thread groove is formed on the rotary shaft 211 and on the rail 212. The thread grooves are opposite each other and coupled to each other. Therefore, when the drive unit 205 is rotationally driven, the rotary shaft 211 rotates and the rail 212 rotates.

The rail 212 extends along one direction. The moving stage 213 (with the antenna 300 placed thereon) is attached to the rail 212.

The moving stage 213 has, for example, a ball screw nut and moves in one direction along the rail 212 as the rail 212 rotates. That is, the moving stage 213 moves in a horizontal direction along an x-axis as shown in FIG. 9. The moving stage 213 also moves forward and backward along the one direction in response to the rotation of the rail 212 in a different direction. In this way, the drive device 200 moves the antenna 300 forward and backward along the one horizontal direction (along the x-axis) along the rail 212.

The hardware configuration of the drive device 200 is not limited to the foregoing configuration. In the drive device 200, one or some of the foregoing components may be omitted and/or modified and an additional component may be added.

The first range and the second range will now be described.

FIG. 10 is a schematic view for explaining a first range 81 and a second range 82 and is a plan view of the counter table 700 as viewed from above.

The first range 81 and the second range 82 are ranges separated from each other in the depicted horizontal plane. The first range 81 is at a center part of the horizontal surface of the counter table 700. The second range 82 is at an outer circumferential part of the horizontal surface of the counter table 700 and may extend to beyond outside edge of the counter table 700. The second range 82 is set to surround the first range 81. In FIG. 10, the first range 81 and the second range 82 are spaced apart from each other and thus are not directly adjacent to each other. That is, there is a gap between the first range 81 and second range 82. However, this example is not limiting. The second range 82 may be adjacent to the first range 81 in other examples.

The setting of the first range 81 and the second range 82 is not limited to this example. The first range 81 may be a range set at a center part of the horizontal surface of the counter table 700 and the second range 82 may be a range set at an outer circumferential part of the horizontal surface of the counter table 700. In some examples, the first range 81 may be a range set over the entire horizontal surface of the counter table 700 and the second range 82 may be a range set horizontally outside the counter table 700. The second range 82 is not limited to a range set to entirely surround the first range 81.

The first range 81 and the second range 82 do not fully overlap each other. The first range 81 and the second range 82 are not limited to horizontally separated ranges. The first range 81 and the second range 82 may be vertically separated ranges.

### Example of Operation

The determination processing by the processor 101 of the reading device 100 will now be described. The determination processing in this context is the processing associated with acquiring data representing the position of each wireless tag 600.

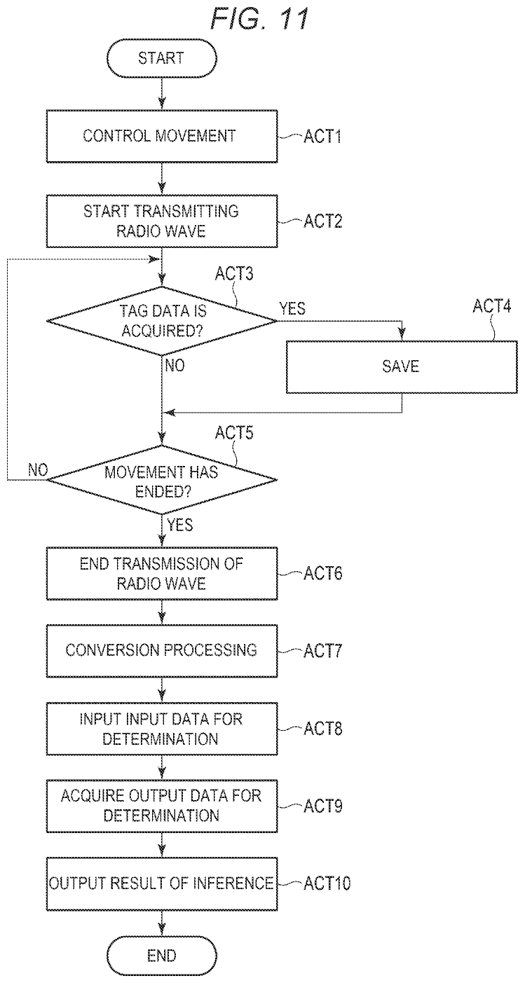

FIG. 11 is a flowchart showing an example of the determination processing by the processor 101 of the reading device 100.

The processing procedures described below are simply an example. Each described process may be changed in various aspects. In the processing procedures described below, an act may be omitted, replaced, or added where appropriate, depending on the specific form of an implemented embodiment.

For example, it is assumed here that an article 500 that is a target of reading the information stored in the wireless tag 600 has been placed on the counter table 700, but other examples need not incorporate a counter table 700. It is also assumed here than another article that is not a target for reading the information stored in a wireless tag 600 is near the counter table 700, but not on the counter table 700.

The processor 101 of the reading device 100 may start the determination processing based on the acquisition of a start instruction input by a user at the terminal 400.

The movement control unit 1011 controls the movement of the antenna 300 (ACT 1). In ACT 1, for example, the movement control unit 1011 transmits a movement instruction to the drive device 200. The movement instruction is an instruction to move the antenna 300 in one direction from the position 0 (corresponding to the home position) to the position L.

The processor 201 of the drive device 200 receives the movement instruction from the reading device 100. The processor 201 determines whether the antenna 300 is presently at the home position or not using the home position sensor 206. If the antenna 300 is not at the home position, the processor 201 controls the drive unit 205 to move the antenna 300 to the home position. The drive unit 205 moves the antenna 300 to the home position under the control of the processor 201. The processor 201 then controls the drive unit 205 to start moving the antenna 300 from the position 0. The drive unit 205 starts moving the antenna 300 from the position 0 under the control of the processor 201. The processor 201 controls the drive unit 205 to move the antenna 300 in one direction from the position 0 to the position L. The drive unit 205 moves the antenna 300 in one direction from the position 0 to the position L under the control of the processor 201.

The communication control unit 1012 controls the start of the transmission of a radio wave (a tag interrogation wave or the like) from the antenna 300 (ACT 2). In ACT 2, for example, the communication control unit 1012 controls the start of the transmission of a radio wave from the antenna 300 based on the start of the movement of the antenna 300 from the position 0. The communication control unit 1012 may control the start of the transmission of a radio wave from the antenna 300 based on a movement start notification from the drive device 200. The movement start notification may indicate that the movement of the antenna 300 from the position 0 has started. The antenna 300 starts transmitting a radio wave for reading the information stored in the wireless tag 600.

The data acquisition unit 1013 acquires the tag data about each wireless tag 600 in reading range (ACT 3). In ACT 3, for example, the data acquisition unit 1013 acquires the tag data about each wireless tag 600 detected by the demodulation unit 110. If the data acquisition unit 1013 has acquired tag data (YES in ACT 3), the processing shifts from ACT 3 to ACT 4. If the data acquisition unit 1013 has not acquired tag data (NO in ACT 3), the processing shifts from ACT 3 to ACT 5.

The data acquisition unit 1013 saves the tag data in the memory device 111 as data of the measurement data 1111 for each wireless tag 600 for which tag data has been acquired (ACT 4).

The communication control unit 1012 determines whether the movement of the antenna 300 has ended or not (ACT 5). In ACT 5, for example, the communication control unit 1012 determines whether the movement of the antenna 300 from the position 0 to the position L has ended or not. The communication control unit 1012 may determine that the movement of the antenna 300 has ended based on a movement end notification from the drive device 200. The movement end notification may indicate that the movement of the antenna 300 has ended upon arriving at the position L. If the movement of the antenna 300 has ended (YES in ACT 5), the processing proceeds from ACT 5 to ACT 6. If the movement of the antenna 300 has not ended (NO in ACT 5), the processing returns from ACT 5 to ACT 3.

The data acquisition unit 1013 repeats the processing of ACT 3 and ACT 4 until the antenna 300 ends the movement at the position L.

In ACT 3, the data acquisition unit 1013 acquires the tag data for each wireless tag 600 at a plurality of positions of the antenna 300 during the antenna 300 movement. For example, the data acquisition unit 1013 can acquire RSSI data about each wireless tag 600 at a plurality of positions of the antenna 300. The data acquisition unit 1013 can also acquire the phase data for each wireless tag 600 at a plurality of positions of the antenna 300. The data acquisition unit 1013 can acquire the position of the antenna 300 in cooperation with the drive device 200.

In ACT 4, the data acquisition unit 1013 saves the tag data for each wireless tag 600 at corresponding positions of the antenna 300 in the memory device 111 as data of the measurement data 1111. For example, the data acquisition unit 1013 can save the RSSI data for each wireless tag 600 for different positions of the antenna 300 in the memory device 111. The data acquisition unit 1013 can save the phase data for each wireless tag 600 for different positions of the antenna 300 in the memory device 111.

The communication control unit 1012 controls to end the transmission of the radio wave from the antenna 300 (ACT 6). In ACT 6, for example, the communication control unit 1012 ends the transmission of the radio wave from the antenna 300 based on the end of the movement of the antenna 300 from the position 0 to the position L. The antenna 300 stops transmitting the radio wave for reading the information stored in the wireless tags 600.

The computation unit 1014 executes the conversion processing for finding/calculating the converted data 1112 based on the measurement data 1111 (ACT 7). In ACT 7, for example, the computation unit 1014 converts the RSSI data and the phase data for each detected wireless tag 600 into in-phase data and quadrature data for the respective wireless tags 600 based on the measurement data 1111. The computation unit 1014 saves the in-phase data and the quadrature data for each wireless tag 600 in the memory device 111 as data of the converted data 1112.

The data input unit 1015 sends (provides) the input data for determination of each wireless tag 600 to the learned model 1114 (ACT 8). In ACT 8, for example, the data input unit 1015 acquires the input data for determination for each detected wireless tag 600 based on the converted data 1112 stored in the memory device 111. The input data for determination includes the position data of the antenna 300 and the in-phase data and the quadrature data for the respective wireless tags 600 for different positions of the antenna 300. The data input unit 1015 sends the acquired input data for determination of each detected wireless tag 600 to the learned model 1114.

The inference result acquisition unit 1016 acquires the output data for determination for each detected wireless tag 600 from the learned model 1114 (ACT 9). The output data for determination includes data representing a position of the respective wireless tags 600.

The output unit 1017 outputs the result of inference to the terminal 400 via the second connection interface 105 (ACT The result of inference includes data representing the position of each wireless tag 600 as acquired as the output data for determination from the inference result acquisition unit 1016. The output unit 1017 may also output the information stored in each wireless tag 600 as read by the reading device 100 to the terminal 400 via the second connection interface 105. The terminal 400 may process the information stored in each wireless tag 600 based whether each wireless tag 600 is determined (inferred) to be located in the first or second range. For example, the terminal 400 may treat the information stored in a wireless tag 600 located in the first range as a processing target. The terminal 400 does not treat the information stored in a wireless tag 600 located in the second range as a processing target.

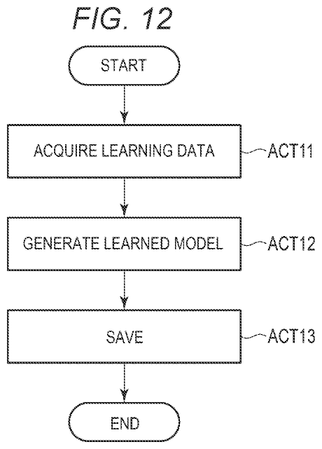

FIG. 12 is a flowchart showing an example of generation processing for the learned model 1114 by the processor 101 of the reading device 100.

The processing procedures described below are simply an example. Each process may be changed as far as possible. In the processing procedures described below, an act may be omitted, replaced, or added where appropriate, depending on the form of embodiment.

The model processing unit 1018 may start the generation processing for the learned model 1114 at any timing and thus may newly generate the learned model 1114. The model processing unit 1018 may start the generation processing for the learned model 1114 at any timing and thus may update an already existing learned model 1114.

The model processing unit 1018 acquires the learning data 1113 (ACT 11). In ACT 11, the model processing unit 1018 acquires the learning data 1113 from the memory device 111.

The model processing unit 1018 generates the learned model 1114 by machine learning using the learning data 1113 (ACT 12). In ACT 12, for example, the model processing unit 1018 receives the learning data 1113 and establishes or updates a learned model 1114 by machine learning. In essence, the model processing unit 1018 estimates a relationship between in-phase data acquired at a plurality of positions of an antenna for a plurality of learning target wireless tags to ground truth data including an actual position of each of the plurality of learning target wireless tags used in providing the learning data 1113. The model processing unit 1018 also similarly estimates a relationship between quadrature data acquired at a plurality of positions of an antenna for the plurality of learning target wireless tags and the ground truth data. The model processing unit 1018 generates the learned model 1114 based on these estimations. The machine learning in this example may include neural networking or the like but is not limited to this.

In general, the in-phase data for a learning target wireless tag changes according to the distance between the antenna and the learning target wireless tag. The pattern of the in-phase data for a learning target wireless tag at different positions of the antenna varies from one position of the learning target wireless tag to another. In some instances, there may be a predetermined correlation between the in-phase data for a learning target wireless tag in relation to antenna positions and the actual position of the learning target wireless tag. The quadrature data for a learning target wireless tag changes according to the distance between the antenna and the learning target wireless tag. In general, the pattern of the quadrature data for a learning target wireless tag in relation to antenna positions varies from one actual position of the learning target wireless tag to another. In some instances, there may be a predetermined correlation between the quadrature data for a learning target wireless tag in relation to antenna position and the actual position of the learning target wireless tag.

The model processing unit 1018 saves the generated learned model 1114 in the memory device 111 (ACT 13).

### Effects

According to the first embodiment, a communication device includes an antenna configured to receive a radio wave transmitted from a wireless tag. The communication device includes a drive unit configured to move a position of the antenna. The communication device includes a detection unit configured to detect received strength data and phase data of the radio wave from the wireless tag received by the antenna. The communication device includes a data input unit configured to input position data of the antenna, and in-phase data and quadrature data for the wireless tag converted based on the received strength data and the phase data for the wireless tag, to a learned model. The communication device includes an inference result acquisition unit configured to acquire data representing a position of the wireless tag from the learned model, based on the input of the position data of the antenna and the in-phase data and the quadrature data for the wireless tag to the learned model. The learned model is a model generated by machine learning based on learning data including the in-phase data and the quadrature data about a plurality of wireless tags in relation to a plurality of positions of the antenna and data representing the position of each of the plurality of wireless tags.

According to the first embodiment, the in-phase data and the quadrature data for the wireless tag are data converted based on data formed by normalizing the received strength data for the wireless tag, based on a predetermined signal strength, and the phase data for the wireless tag.

Thus, the communication device can determine the position of the wireless tag, using the learned model having learned the in-phase data and the quadrature data, which do not change discontinuously while the position of the antenna changes continuously. Therefore, in the communication device, the accuracy of determining the position of the wireless tag can be improved.

### Second Embodiment

A communication system according to a second embodiment will now be described.

The second embodiment differs from the first embodiment in that an electronic device that is different from the communication device 10 determines the position of each wireless tag 600.

The components similar to those in the first embodiment are denoted by the same reference signs and are not described in further detail. In the second embodiment, the difference from the first embodiment is mainly described. In the drawings, the same components are denoted by the same reference signs as far as possible and are not described repeatedly.

### Example of Configuration

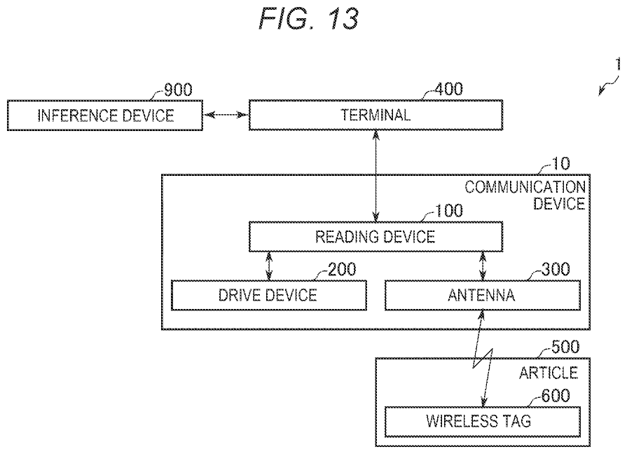

FIG. 13 is a block diagram showing an example of the configuration of a communication system 1.

As in the first embodiment, the communication system 1 includes a communication device 10, a terminal 400, and one or more wireless tags 600 attached to one or more articles 500. The communication system 1 also includes an inference device 900 in this second embodiment, unlike in the first embodiment.

The inference device 900 is an electronic device that handles the processing for determination of the position of each wireless tag 600. An example of the configuration of the inference device 900 will be described below.

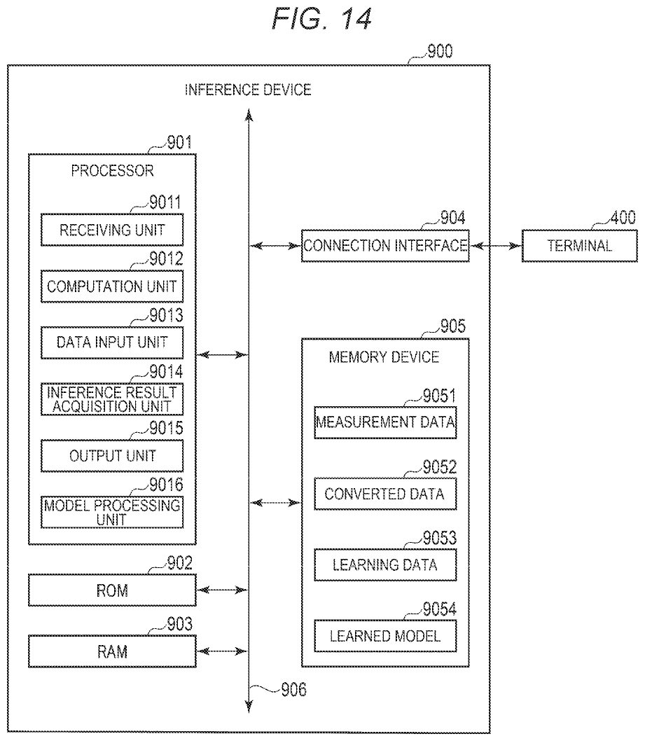

The inference device 900 will now be described, using FIG. 14.

FIG. 14 is a block diagram showing an example of the configuration of the inference device 900.

The inference device 900 includes a processor 901, a ROM 902, a RAM 903, a connection interface 904, and a memory device 905. These components included in the inference device 900 are connected to each other via a bus 906 or the like.

The processor 901 is equivalent to a central part of a computer that performs necessary processing such as computation and control for the operation of the inference device 900. The processor 901 loads various programs stored in the ROM 902 or the memory device 905 or the like into the RAM 903. The program is a program for causing the processor 901 to execute various kinds of processing. The processor 901 executes the program loaded in the RAM 903, thus implements units, described below, and thus executes various kinds of processing. The processor 901 is a CPU, an MPU, a SoC, a DSP, a GPU, an ASIC, a PLD, or an FPGA or the like. The processor 901 may be a combination of a plurality of devices, of these devices. The processor 901 is an example of a processing circuit.

The ROM 902 is a non-volatile memory used exclusively to read data. The ROM 902 stores the foregoing program. The ROM 902 stores data or various set values or the like used by the processor 901 to perform various kinds of processing.

The RAM 903 is a memory used to read and write data. The RAM 903 is a work area for storing data temporarily used by the processor 901 to perform various kinds of processing.

The connection interface 904 is an interface for the inference device 900 to communicate with the terminal 400.

The memory device 905 includes a non-volatile memory storing data and a program or the like. The memory device 905 is formed of an HDD or an SSD or the like but is not limited to these examples. The memory device 905 is an example of a memory unit.

The memory device 905 stores measurement data 9051.

The measurement data 9051 is data similar to the measurement data 1111 described in the first embodiment. The measurement data 9051 is data acquired by the reading device 100. For example, the inference device 900 can receive the measurement data 9051 transmitted from the reading device 100, via the terminal 400.

While an example where the memory device 905 stores the measurement data 9051 is described, this example is not limiting. The RAM 903 may store the measurement data 9051.

The memory device 905 stores converted data 9052.

The converted data 9052 is data similar to the converted data 1112 described in the first embodiment.

While an example where the memory device 905 stores the converted data 9052 is described, this example is not limiting. The RAM 903 may store the converted data 9052.

The memory device 905 stores learning data 9053.

The learning data 9053 is data similar to the learning data 1113 described in the first embodiment.

The memory device 905 stores a learned model 9054.

The learned model 9054 is a model similar to the learned model 1114 described in the first embodiment.

The bus 906 includes a control bus, an address bus, and a data bus or the like. The bus 906 transmits a signal communicated between the components of the inference device 900.

The hardware configuration of the inference device 900 is not limited to the foregoing configuration. In other examples of the inference device 900, one or some of the foregoing components may be omitted or modified and a new component may be added, where appropriate.

Each unit (function) implemented by the processor 901 will now be described.

The processor 901 implements a receiving unit 9011, a computation unit 9012, a data input unit 9013, an inference result acquisition unit 9014, an output unit 9015, and a model processing unit 9016. Each unit implemented by the processor 901 can also be referred to as a function. It can also be said that each unit implemented by the processor 901 is implemented by a control unit including the processor 901, the ROM 902, and the RAM 903.

The receiving unit 9011 receives the measurement data 9051 from the terminal 400. Receiving the measurement data 9051 includes receiving the tag data set of each wireless tag 600.

The computation unit 9012 executes conversion processing of finding the converted data 9052, based on the measurement data 9051, similarly to the computation unit 1014 described in the first embodiment. For example, the computation unit 9012 converts the RSSI data and the phase data for the wireless tag 600 into the in-phase data and the quadrature data for the wireless tag 600.

The data input unit 9013 sends the input data for determination for each detected wireless tag 600 to the learned model 9054, in a manner similar to the data input unit 1015 described in the first embodiment.

The inference result acquisition unit 9014 acquires the output data for determination of each wireless tag 600 from the learned model 9054, in a manner similar to the inference result acquisition unit 1016 described in the first embodiment.

The output unit 9015 outputs the result of inference to the terminal 400. In this context, the result of inference includes data indicating the position of each detected wireless tag 600 as output by the inference result acquisition unit 9014.

The model processing unit 9016 generates the learned model 9054, similarly to the model processing unit 1018 described in the first embodiment. The generation processing for the learned model 9054 by the model processing unit 9016 may be similar to the generation processing for the learned model 1114 by the model processing unit 1018 described using FIG. 12 in the first embodiment and therefore is not described further in detail.

### Example of Operation

The determination processing by the processor 901 of the inference device 900 configured as described above will now be described. The determination processing in this context is the processing of acquiring data representing or otherwise indicating the position of each detected wireless tag 600.

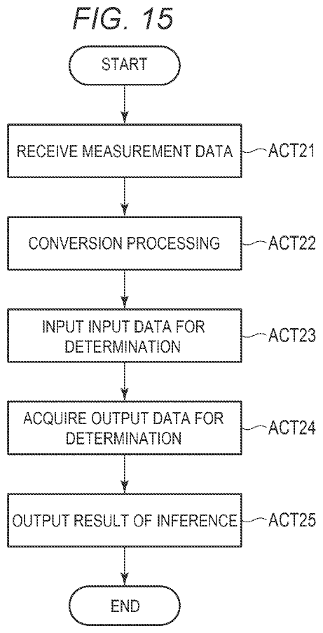

FIG. 15 is a flowchart showing an example of the determination processing by the processor 901 of the inference device 900.

The processing procedures described below are simply an example. Each process may be changed as far as possible. In the processing procedures described below, an act may be omitted, replaced, or added where appropriate, depending on the form of embodiment.

The receiving unit 9011 receives the measurement data 9051 from the terminal 400 via the connection interface 904 (ACT 21). In this example, the processor 101 of the reading device 100 transmits the measurement data 9051 to the terminal 400 via the second connection interface 105. In ACT 21, for example, the receiving unit 9011 receives the measurement data 9051 transmitted from the reading device 100 via the terminal 400. The receiving unit 9011 saves the received measurement data 9051 in the memory device 905.

The computation unit 9012 executes the conversion processing of finding (calculating) the converted data 9052 based on the measurement data 9051 (ACT 22). In ACT 22, for example, the computation unit 9012 converts the RSSI data and the phase data for each wireless tag 600 into the in-phase data and the quadrature data for each wireless tag 600. The computation unit 9012 saves the in-phase data and the quadrature data for each wireless tag 600 in the memory device 905 as data of the converted data 9052.

The data input unit 9013 sends the input data for determination for each wireless tag 600 to the learned model 9054 (ACT 23). In ACT 23, for example, the data input unit 9013 acquires the input data for determination of each wireless tag 600 as the converted data 9052 stored in the memory device 905. The input data for determination includes the position data of the antenna 300 and the in-phase data and the quadrature data for the wireless tag 600 for different positions of the antenna 300. The data input unit 9013 sends the acquired input data for determination of each wireless tag 600 to the learned model 9054.

The inference result acquisition unit 9014 acquires the output data for determination of each wireless tag 600 from the learned model 9054 (ACT 24). The output data for determination includes data indicating the position of the respective wireless tags 600.

The output unit 9015 outputs the result of inference to the terminal 400 via the connection interface 904 (ACT 25).

While the receiving unit 9011 in ACT 21 receives the measurement data 9051 from the terminal 400 via the connection interface 904 in this example, this is not limiting. The receiving unit 9011 may receive the converted data 9052 instead of the measurement data 9051 from the terminal 400 via the connection interface 904. Receiving the converted data 9052 includes receiving the converted tag data set of each wireless tag 600. In this example, the processor 101 of the reading device 100 executes the conversion processing of finding the converted data 9052, based on the measurement data 9051, as in the first embodiment. The processor 101 of the reading device 100 transmits the converted data 9052 to the terminal 400 via the second connection interface 105. The receiving unit 9011 receives the converted data 9052 transmitted from the reading device 100, via the terminal 400. The receiving unit 9011 saves the received converted data 9052 in the memory device 905. In this example, the processing of ACT 22 is omitted.

While an example where the receiving unit 9011 receives the measurement data 9051 or the converted data 9052 from the terminal 400 and where the output unit 9015 outputs the result of inference to the terminal 400 is described, this example is not limiting. The receiving unit 9011 may receive the measurement data 9051 or the converted data 9052 from the communication device 10, and the output unit 9015 may output the result of inference to the communication device 10. The sender of the data and the destination of the result of inference may not be the same electronic device. For example, the receiving unit 9011 may receive the measurement data 9051 or the converted data 9052 from the communication device 10, and the output unit 9015 may output the result of inference to the terminal 400.

### Effects

According to the second embodiment, an inference device includes a data input unit configured to input position data of an antenna, and in-phase data and quadrature data about a wireless tag converted based on received strength data and phase data of a radio wave from the wireless tag received by the antenna to a learned model. The inference device includes an inference result acquisition unit configured to acquire data representing a position of the wireless tag from the learned model, based on the input of the position data of the antenna and the in-phase data and the quadrature data for the wireless tag to the learned model. The learned model is a model generated by machine learning based on learning data including the in-phase data and the quadrature data about a plurality of wireless tags in relation to a plurality of positions of the antenna and data representing the position of each of the plurality of wireless tags.

According to the second embodiment, the inference device further includes a receiving unit configured to receive the received strength data and the phase data for the wireless tag in relation to the plurality of positions of the antenna or the in-phase data and the quadrature data for the wireless tag in relation to the plurality of positions of the antenna.

According to the second embodiment, the in-phase data and the quadrature data for the wireless tag are data converted based on data formed by normalizing the received strength data for the wireless tag, based on a predetermined signal strength, and the phase data for the wireless tag.

Thus, the inference device can determine (identify) the position of the wireless tag using a learned model incorporating the in-phase data and the quadrature data, which do not change discontinuously while the position of the antenna changes continuously. Therefore, in the inference device, the accuracy of determining the position of the wireless tag can be improved.

### Other Embodiments

In the foregoing embodiments, in general, a plurality of wireless tags 600 are present as a detection target. However, a single wireless tag 600 may be employed as a detection target.

In the foregoing embodiments, both the in-phase data and the quadrature data are supplied for a target. However, in some examples, just one of the in-phase data or the quadrature data may be employed instead of both.

While an example where the processor of a tag reading device implements the model processing unit that generates a learned model is described, this example is not limiting. The generation of the learned model may be implemented by a different device from the reading device and the learned model subsequently supplied to the reading device.

While an example where the processor of the inference device implements the model processing unit generating the learned model is described, this example is not limiting. The generation of the learned model used by the inference device may be performed by a different device from the inference device with the learned model being supplied to the inference device subsequently.

While an example where the memory device of the reading device stores the learning data and the learned model is described, this example is not limiting. Either or both of the learning data and the learned model may be stored in a different device from the reading device.

While an example where the memory device of the inference device stores the learning data and the learned model is described, this example is not limiting. Either or both of the learning data and the learned model may be stored in a different device from the inference device.

The communication device may be implemented by a plurality of devices as described in the foregoing example or may be implemented by one device with functions of the plurality of devices integrated therein. The reading device, the drive device, and the antenna may be implemented by one device with functions integrated therein. The reading device may be implemented by a plurality of devices with functions distributed thereto.

The inference device may be implemented by one device as described in the foregoing example or may be implemented by a plurality of devices with functions distributed thereto.

A software program or the like for implementing described functions of the above embodiments may be prestored in an electronic device according to the embodiments or may be provided separately or subsequently from the electronic device(s). In the latter case, the program may be provided via a network or in a non-transitory tangible recording medium that is a computer-readable medium. In general, such a recording medium may be any medium that can store a program and that can be read by a computer, such as a CD-ROM or a memory card, and is not limited to any specific form.

While some embodiments have been described, these embodiments are presented simply as examples and are not intended to limit the scope of the present disclosure. These novel embodiments can be carried out in various other forms and can include various omissions, replacements, and modifications without departing from the spirit and scope of the present disclosure. These embodiments and the modifications thereof are included in the spirit and scope of the present disclosure and also included in the scope of the claims and equivalents thereof.

What is claimed is:

1. A wireless tag reading device, comprising:
an antenna configured to receive a radio wave transmitted from a wireless tag;
a drive unit configured to move the antenna through different positions along a fixed path;
a detection unit configured to determine a received signal strength and a phase of the radio wave received by the antenna; and
a processor configured to:
receive position data indicating a position of the antenna in conjunction with the received signal strength and the phase of the radio signal received by the antenna at the position,
calculate in-phase data and quadrature data for the wireless tag based on the received signal strength and the phase of the radio signal at a plurality of positions of the antenna,
input the in-phase data and the quadrature data for the wireless tag to a learned model correlating in-phase data and quadrature data to positions of wireless tags, and
estimate a position of the wireless tag using output of the learned model.

2. The wireless tag reading device according to claim 1, wherein the learned model is a model generated by machine learning.

3. The wireless tag reading device according to claim 1, wherein the in-phase data and the quadrature data for the wireless tag are calculated based on data formed by normalizing the received strength data for the wireless tag based on a predetermined signal strength and the phase data for the wireless tag.

4. The wireless tag reading device according to claim 3, wherein the processor is configured to identify whether the wireless tag is within a first region or outside the first region when estimating the position of the wireless tag using the learned model.

5. The wireless tag reading device according to claim 3, wherein the learned model is generated from learning data including in-phase data and quadrature data for a plurality of wireless tags at known positions.

6. The wireless tag reading device according to claim 3, wherein the processor is configured to generate the learned model from learning data including in-phase data and quadrature data for a plurality of wireless tags at known positions.

7. The wireless tag reading device according to claim 1, wherein the processor is configured to identify whether the wireless tag is within a first region or outside the first region when estimating the position of the wireless tag using the learned model.

8. The wireless tag reading device according to claim 1, wherein the learned model is generated from learning data including in-phase data and quadrature data for a plurality of wireless tags at known positions.

9. The wireless tag reading device according to claim 1, wherein the processor is configured to generate the learned model from learning data including in-phase data and quadrature data for a plurality of wireless tags at known positions.

10. A position inference device, comprising:
a processor configured to:
acquire position data of an antenna and in-phase data and quadrature data for a wireless tag in association with the position data of the antenna, the in-phase data and quadrature data being calculated based on received signal strength data and phase data of a radio wave from the wireless tag as received by the antenna,
input the acquired position data for the antenna and the in-phase data and quadrature data to a learned model, and
acquire data estimating a position of the wireless tag from the learned model based on the acquired position data of the antenna and the in-phase data and the quadrature data for the wireless tag.

11. The position inference device according to claim 10, wherein the learned model is a model generated by machine learning.

12. The position inference device according to claim 10, wherein the processor is further configured to:
receive the received signal strength data and the phase data for the wireless tag in relation to a plurality of positions of the antenna and acquire the in-phase data and the quadrature data for the wireless tag by calculation using the received signal strength data and the phase data.

13. The position inference device according to claim 10, wherein the in-phase data and the quadrature data for the wireless tag are calculated based on data formed by normalizing the received strength data for the wireless tag based on a predetermined signal strength and the phase data for the wireless tag.

14. The position inference device according to claim 10, wherein the processor is configured to identify whether the wireless tag is within a first region or outside the first region when estimating the position of the wireless tag using the learned model.

15. The position inference device according to claim 10, wherein the processor is configured to generate the learned model from learning data including in-phase data and quadrature data for a plurality of wireless tags at known positions.

16. A wireless tag position estimation method executed by an electronic device, the method comprising:
receive position data indicating a position of the antenna in conjunction with a received signal strength and a phase of a radio signal received from a wireless tag by an antenna at the position;
calculate in-phase data and quadrature data for the wireless tag based on the received signal strength and the phase of the radio signal at a plurality of positions of the antenna;
input the in-phase data and the quadrature data for the wireless tag to a learned model correlating in-phase data and quadrature data to positions of wireless tags; and
estimate a position of the wireless tag using output of the learned model.

17. The method according to claim 16, wherein the learned model is a model generated by machine learning.

18. The method according to claim 16, wherein the in-phase data and the quadrature data for the wireless tag are calculated based on data formed by normalizing the received strength data for the wireless tag based on a predetermined signal strength and the phase data for the wireless tag.

19. The method according to claim 16, further comprising:
identify whether the wireless tag is within a first region or outside the first region when estimating the position of the wireless tag using the learned model.

20. The method according to claim 16, wherein the learned model is generated from learning data including in-phase data and quadrature data for a plurality of wireless tags at known positions.
